(19) United States
(12) Patent Application Publication
(10) Pub. No.: US 2002/0062365 A1
(43) Pub. Date: May 23, 2002

(54) Control of electronic appliances over network

(75) Inventors: Youichiro Nishikawa, Osaka (JP); Takeshi Yumura, Osaka (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD.

(21) Appl. No.: 09/880,731

(22) Filed: Jun. 13, 2001

(30) Foreign Application Priority Data
Jun. 13, 2000 (JP) 2000-177621

(51) Int. Cl. G06F 15/16

(52) U.S. Cl. 709/223; 709/203

(57) ABSTRACT

Currently, when a user remotely controls a home server via the Internet, the home server must be continuously connected to the Internet. This continuous connection has room for improvement in terms of security and communication costs. A user terminal calls a home server, which issues a connection request to an Internet service provider. The provider connects the server to the Internet and allots an IP address to the server. The server sends this address to the user terminal, which issues to the home server a control request over a home network device using the IP address. The home server sends a command to the home network device and receives a status report from the device. The status is thus conveyed to the user.

### BACKGROUND OF THE INVENTION

1. Field of the Invention

This invention relates to an information processing technique, especially to an information processing method and an apparatus controllable by a remote user or information terminal.

2. Description of the Related Art

It is expected that home networks will play a more and more important role as demand increases for devices to create a more comfortable life environment in line with personal preferences and as information technology (IT), including network technology becomes more refined. Until recently, the idea of controlling various home electrical appliances from outside via a home network was merely a long-held dream. Today, technical solutions to achieve this dream are at hand. People have strong expectations and various wishes concerning home networks, as they now have direct experience of the convenience of networks such as the Internet and cellular phone networks.

It is still necessary, however, to have a device which manages the home network (hereinafter referred to as a “home server”) maintain continuous connection to the Internet in order to operate the home network from outside. There are few users who would be willing to pay the relatively expensive cost of such continuous connection, even though communication costs are generally going down. Cost is a major factor in the introduction of home networks to large numbers of homes.

A further problem is that of information security on the Internet. Users need to be extremely wary about establishing a route to their home appliances by means of an open network to which many people have access. Manufacturers and promoters of home network systems envisage that the security on the Internet is a challenging task must be overcome before they can increase the market and at the same time improve the service.

### SUMMARY OF THE INVENTION

It is therefore an object of the present invention to provide a technique to reduce communication costs of operating for example a home server from outside the home. A further object is to improve the security of the server when it is operated from outside the home. The present invention can be applied not only to a home server but also to other ordinary servers including FA/OA servers and to stand-alone devices which are not servers. It is therefore a general object of the present invention to provide information processing technology to allow remote control while improving convenience, security and cost-effectiveness.

The objects are achieved by combinations described in the independent claims. The dependent claims define further advantageous and exemplary combinations of the present invention.

According to one aspect of the present invention, an information processing apparatus operable from a remote user is provided. The apparatus comprises a communication unit which provides a function to interface with a network; a connection request unit which generates a request to establish a connection with the network; an address holder which holds a logical address allotted when the connection is established; and a server functional unit which provides a predetermined service, when a network node of the user accesses the apparatus using the sent logical address, to the node as a client.

In this configuration, the interface function of the communication unit establishes the connection between this apparatus and the network when a request for connection is issued. A logical address on the network is transmitted to and stored in the apparatus. The address is reported to the user node or a user terminal. The user node then accesses the apparatus using the address. The server function unit provides a prepared service to the user node.

When the network is the Internet, the apparatus may dial up an Internet service provider (ISP) to connect to the Internet via Point-to-Point Protocol (PPP) obtaining a temporary logical address or an Internet Protocol (IP) address assigned by the ISP. The address is transmitted to a user node such as a mobile phone, or some other mobile device, which can then access the apparatus via the Internet. The apparatus provides a service to the user node as a World Wide Web (WWW) server and the like. The service may provide information in a specific category.

The apparatus may further comprise a monitor unit which detects a trigger signal transmitted by a remote node in compliance with a communication protocol which does not require connection to the network. The connection request unit may generate the request upon detecting the signal. Here, it is assumed that the apparatus and the network are not connected in a normal mode and the trigger signal is not sent via the network. The operator of the remote node may be or may not be a user of the apparatus or the owner thereof.

When the network is the Internet, the remote node may send the trigger signal to the apparatus via an ordinary public line. The signal may be an ordinary audio signal sent by telephone. The signal may be sent in an electromagnetic optical or any other manner.

The apparatus may further comprise a second communication unit which communicates with an external appliance which is under the control of the apparatus; and an appliance controller which controls the external appliance via the second communication unit. The server function unit, as the predetermined service, may receive an instruction for the control of the external appliance from the user node and may then transmit the instruction to the appliance controller. The appliance controller may convert the instruction to a control command to the external appliance and may send the command to the appliance via the second communication unit.

The apparatus may be a home server and the external appliance may be an electric device connected to the home network. In this configuration, the apparatus acts as a WWW or any other server to the user and as a control server to the external appliance.

The apparatus may further comprise a second monitor unit which generates a trigger signal when status of the external appliance reported via the second communication unit satisfies a predetermined condition. The connection request unit may generate the request upon detecting the signal generated by the second monitor unit. The status may be a flag indicating error occurrence, timing or situation to be reported to the user regardless of whether there is an error, or timing or situation to request instructions from the user.

The apparatus may further comprise a third monitor unit which generates a trigger signal when information from a sensor sensing ambient environment satisfies a predetermined condition. The connection request unit may generate the request upon detecting the signal generated by the third monitor unit. “Ambient environment” may be any environment in which the sensor is set. The sensor may gauge temperature, humidity, change in the composition of the air, change of image or sound, or the like. In the case of a home server, the user can monitor any important change of conditions in his/her home.

The apparatus may further comprise a disconnection request unit which disconnects from the network when access from the logical address has been suspended for a predetermined period. This helps to cut needless communication costs.

The apparatus may further comprise an authentication unit which determines whether the remote node that issued the trigger signal is a user node managed by the apparatus. In this configuration, the connection request unit may generate a request only when the remote node is authenticated as the user node, and in this manner will improve network security.

One aspect of the apparatus according to the present invention when the network is assumed to be the Internet is an information processing apparatus operable by a remote user and comprises a communication unit which dials up an ISP; a connection request unit which requests the initiation of the dial up operation; an address holder which holds a temporary IP address allotted when the connection to the Internet is established; an address reporting unit which forwards an e-mail message to the user node to report the allotted address, and a server function unit which acts as a WWW server to the user node or a client when the node establishes access to the server using the allotted IP address.

According to another aspect of the present invention, an information processing method operable by a remote user is provided. The method comprises waiting in a stand-by mode in an off-line state as an initial state; establishing connection with a network upon detecting a predetermined trigger signal; receiving and holding a logical address allotted when the connection is established; sending the held logical address to a network node of the user; and providing a predetermined service, when a network node of the user accesses the sent logical address to the node as a client. By this method, relatively low communication costs and high security are achieved as the initial state is off-line. The service is realized with a relatively simple configuration.

This summary of the invention does not necessarily describe all necessary features so that the invention may also be a sub-combination of these described features.

### BRIEF DESCRIPTION OF THE DRAWINGS

FIG. 1 shows the entire system using a home server according to one embodiment of the present invention.

FIG. 2 shows an internal structure of the home server according to one embodiment.

FIG. 3 shows a procedure to utilize the home server from the user terminal.

FIG. 4 shows a procedure to utilize the home server from the user terminal.

FIG. 5 shows a procedure to utilize the home server from the user terminal.

FIG. 6 shows a procedure to utilize the home server from the user terminal.

FIG. 7 shows a procedure to utilize the home server from the user terminal.

FIG. 8 is a flow chart showing communication involving the user terminal, a provider, the home server and a home network appliance.

FIG. 9 illustrates a screen displayed on the user terminal when the user operates the home network appliance from the user terminal.

FIG. 10 illustrates a screen displayed on the user terminal when the user operates the home network appliance from the user terminal.

FIG. 11 illustrates a screen displayed on the inner terminal when the user operates the home network appliance from the user terminal.

### DETAILED DESCRIPTION OF THE INVENTION

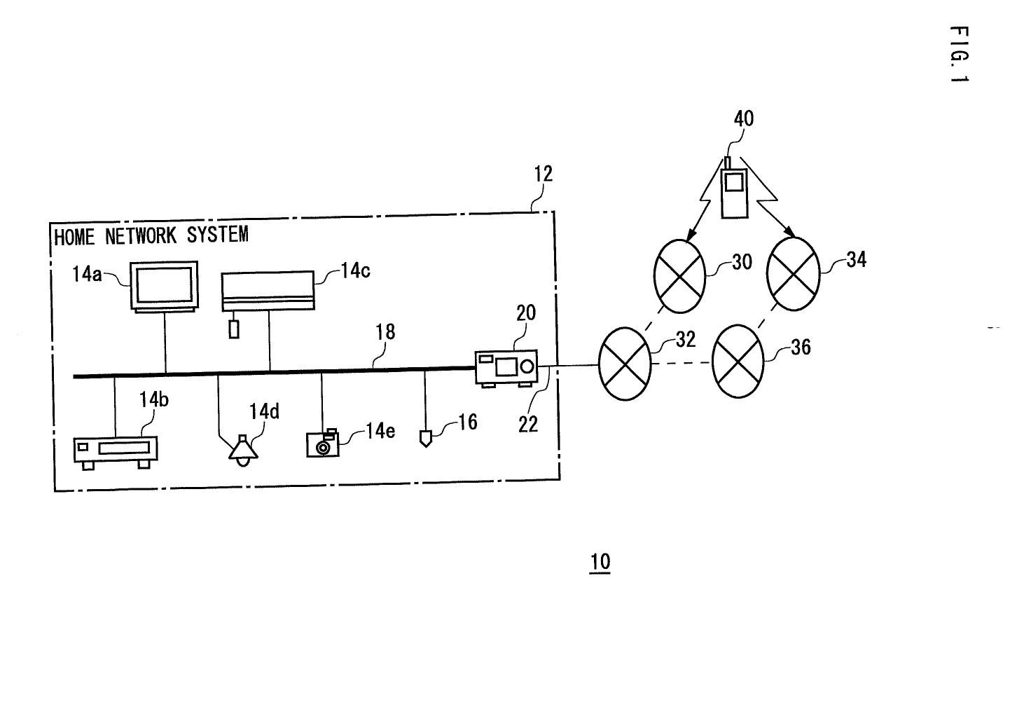

FIG. 1 shows the entire system 10 including an information processing apparatus according to the present embodiment. A home server 20 is an information processing apparatus which is operable by a remote user. The home server 20 manages the entire home network system 12 installed in the user's home. A home network bus 18 controlled by the home server 20 has connections to a television set 14a, a VCR 14b, an air conditioner 14c, a lighting appliance 14d and a digital still camera 14e which are examples of home network appliances 14 linked thereto. A sensor 16 is also linked to the home network bus 18. The home server 20 is connected to a public switched network 32 via a telephone line 22 and establishes a connection to the Internet 36 via an Internet service provider, or ISP (which hereinafter is simply called a provider), by dial-up connection.

A user terminal 40, on the other hand, is a user terminal and has a function to connect to the Internet 36. The user terminal 40, for example, permits voice communication via a mobile phone network 30 which is an analog network and establishes access to the Internet 36 via a mobile phone packet network 34 which is a digital network. There are, however, various communication protocols the user terminal 40 may use, and the selection of a protocol is not an essential matter.

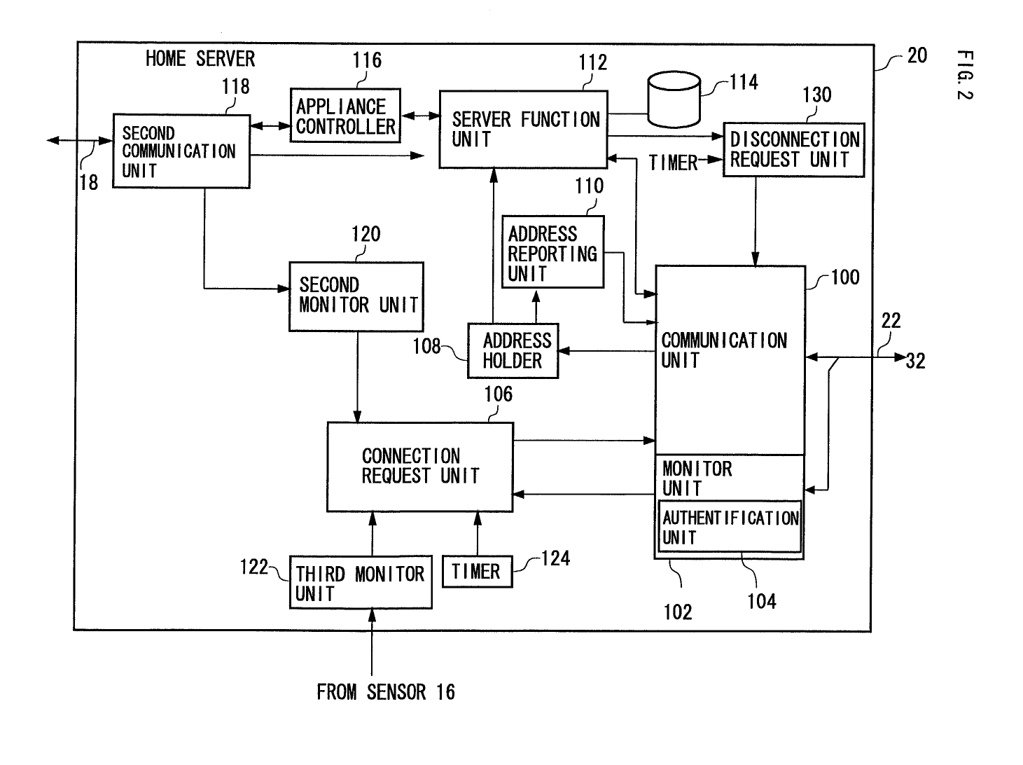

FIG. 2 shows an internal structure of the home server 20. The structure may be realized with hardware elements such as the central processing unit (CPU) of a computer, and memory, and software components such as various functional programs loaded in the memory. It is easily understood by an ordinary skilled in the art that FIG. 2 is drawn in terms of functional blocks with an arbitrary combination of hardware and software.

A communication unit 100, containing a modem and various communication control programs, communicates with outside devices via the telephone line 22. A monitor unit 102 processes a call by detecting a call sound when the home server 20 is called by the user terminal 40. An authentication unit 104 verifies the ID of a user who has called the home server 20. The authentication unit 104 issues an initiation command to a connection request unit 106 when the user is verified to be a genuine user or another person whose access has been allowed by the user. The authentication unit 104 identifies the user on the basis of an allotted caller number.

The connection request unit 106 connects to the Internet 36 by PPP by a dial up to the provider via the communication unit 100. An IP address, which is a network logical address, is allotted to the communication unit 100 when the connection is established. An address holder 108 receives and holds for future communication the IP address (which is hereinafter called a server address), via the communication unit 100. The IP address is sent to a server function unit 112 and an address reporting unit 110. The address reporting unit 110 generates an e-mail containing the server address in the mail text and sends it, when necessary to the user terminal 40 after encrypting the e-mail message.

The user terminal 40 receives the e-mail and accepts the server address. The user terminal 40 then gains access to the home server 20 via the Internet 36 using the server address. When the access is successfully established, the home server 20 starts to function as a WWW server for the user terminal 40. The server function unit 112 comprises a series of components to realize the functions of the WWW server. A screen data storage 114 stores therein screen images in HTML text data and so on to be displayed on the user terminal 40.

When the user issues an instruction to control a home network appliance 14 on the screen provided by the server function unit 112, the instruction is accepted by a common gateway interface (CGI) behind the server function unit 112 and is transmitted to an appliance controller 116.

The appliance controller 116 converts the instruction to a control command to the target home network appliance 14 and sends the command to a second communication unit 118. The second communication unit 118 sends the control command to the target appliance 14 and receives from the appliance 14 a returned status report showing the result of a process activated by the command. The status may show that the present operational condition of the target appliance 14 is normal, the process result of the target appliance 14 initiated by the command is normal, or issue a report on the process result. When the user, for example, instructs the VCR 14b to record a certain TV program, the user is notified by means of the screen image that the settings have been properly entered. A procedure to initiate the home server 20 by a trigger made with a user's call has been explained.

The home server 20 may be activated by a trigger signal from the home network appliance 14 or the sensor 16. The VCR 14b may report the occurrence of an abnormal situation to the second communication unit 118 as a status, for example, when there is not sufficient VCR tape to record the TV program the user wishes to record. The second monitor unit 120 monitors the status and issues a request for activation to the connection request unit 106 when necessary. The types of status which are to be reported to the user may be set beforehand in the second monitor unit 120. Besides spontaneous initiation from the user, the user can access the home server 20 after the user has received an electronic mail message from the address reporting unit 110.

The sensor 16 also issues a trigger signal, for example, when the room temperature becomes too high. In this case, a fire alarm may be transmitted to the user terminal 40. The room temperature, or humidity, may go beyond the allowable range although it is not high enough to issue the fire alarm, in which case, the user terminal 40 may be informed of the situation so that the user can switch on the air conditioner 14c. The types of data that the sensor 16 is to report to the user terminal 40 may be registered beforehand in a third monitor unit 122 so that user customization is realized.

The initiation of the connection request unit 106 may also be done by a timer 124. The interception of the timer 124 can initiate the connection request unit 106 at a predetermined time or with a predetermined time interval. By means of the timer 124, the user can be made aware of the environment or situation of the home periodically or at a predetermined time even where there is no abnormal situation.

A disconnection request unit 130 issues an instruction to the communication unit 100 to disconnect the home server 20 from the Internet 36 when access from the user terminal 40 to the home server 20 has been suspended for a predetermined interval. The disconnection request unit 130 refers to the output of the timer 124 or a clock IC, not shown, to measure the time interval.

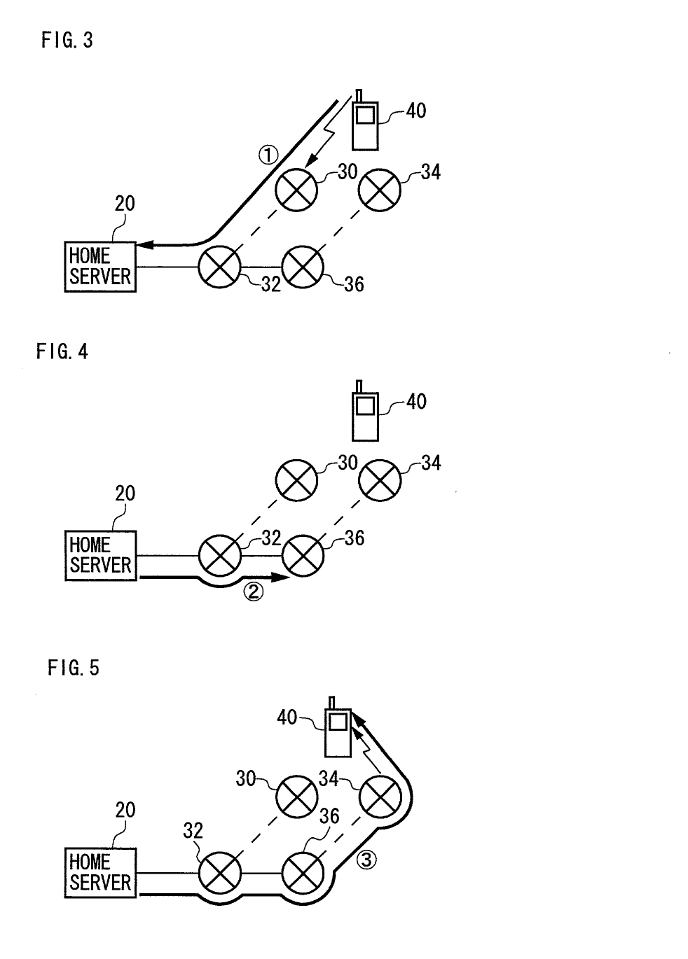

FIGS. 3 to 7 show the network between the user terminal 40 and the home server 20 used when the user terminal 40 initiates the home server 20. The user first makes a normal phone call from the user terminal 40 via a mobile phone network 30 and a public switched network 32 (FIG. 3(1)). The home server 20 is triggered by the call and establishes a connection to the Internet 36 via the public switched network 32 (FIG. 4(2)). When the connection is established, the home server 20 receives the server address and generates an electronic mail message containing the address. The mail is then sent to the user terminal 40 via the public switched network 32, the Internet 36, a mobile phone packet network 34 and so on (FIG. 5(3)). The user may set the user terminal 40 in a normal stand-by mode for reception after the call until the e-mail is received.

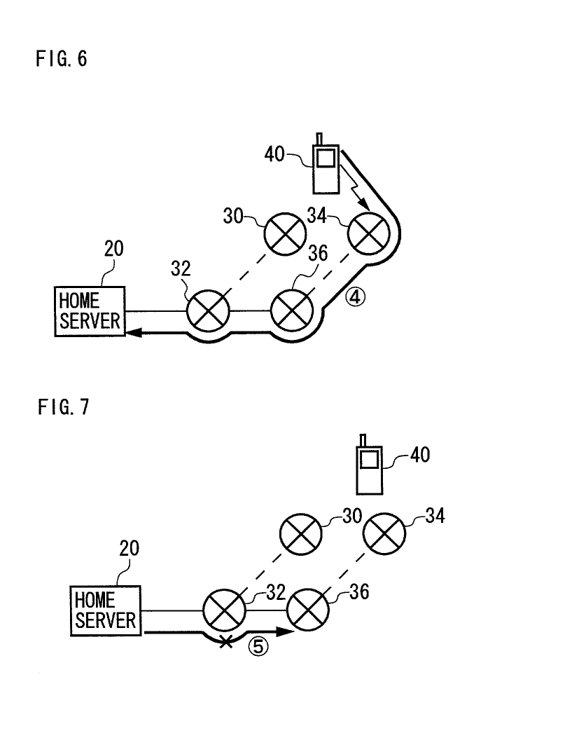

When the e-mail is received by the user terminal 40, the user inputs the allotted server address to access to the home server 20 via the mobile phone packet network 34, the public switched network 32 and so on (FIG. 6(4)). After the communication between the home server 20 and the user terminal 40 necessary to control the home network appliance 14 and so on is completed, the user terminal 40 sends a notice of process completion to the home server 20, which disconnects from the Internet 36 (FIG. 7 (5)).

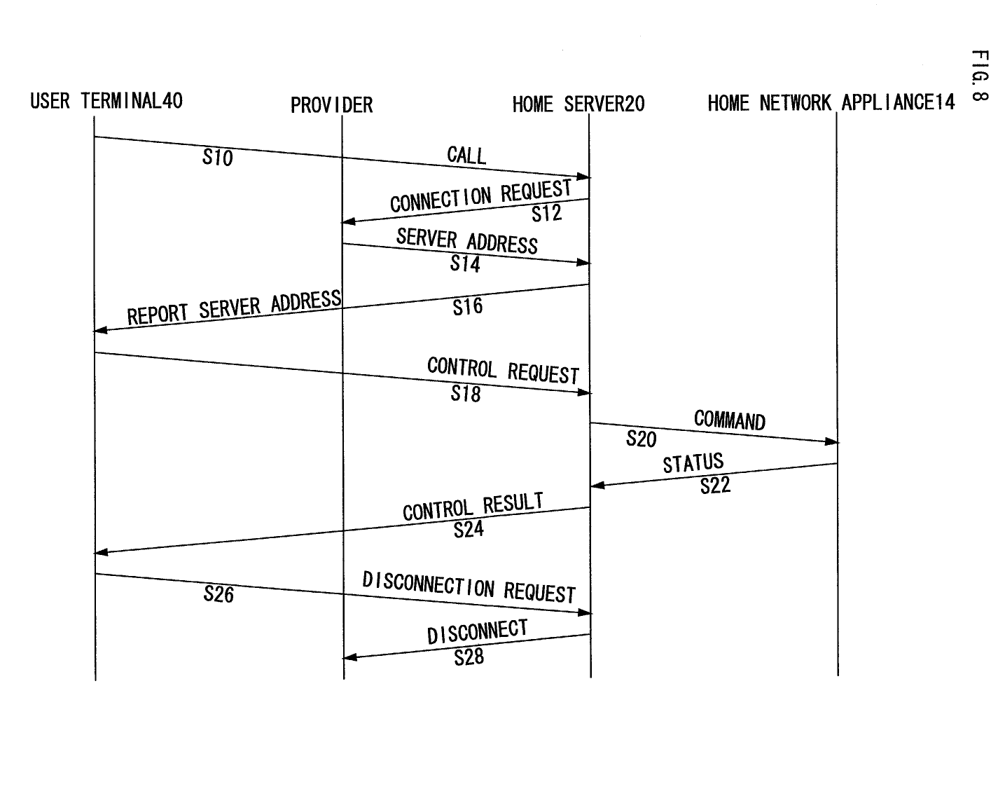

FIG. 8 shows a detailed communication involving the user terminal 40, a provider, the home server 20 and the home network appliance 14. The user terminal 40 first calls the home server 20 (S10). The home server 20 sends a connection request to the provider (S12). The provider, after authenticating the home server 20, connects the home server 20 to the Internet 36 and transmits the allotted server address to the home server 20 (S14).

The home server 20 sends an e-mail containing the report server address to the user terminal 40 (S16). The user terminal 40 accesses the home server 20 via the Internet 36 and issues a control request over the home network appliance 14 (S18). The home server 20 translates the request into a command which can be interpreted and executed by the home network appliance 14 and sends the command to the home network appliance 14 (S20). The home server 20 then receives a status report from the home network appliance 14 (S22). The status is reported to the user terminal 40 as a control result (S24). After the necessary control is completed, the user terminal 40 issues a disconnection request (S26). The home server 20 is then disconnected from the Internet 36 (S28). The disconnection request may be received by the server function unit 112, which is then processed with a function such as CGI and the like. The process for the home network appliance 14 to return the status report can be skipped.

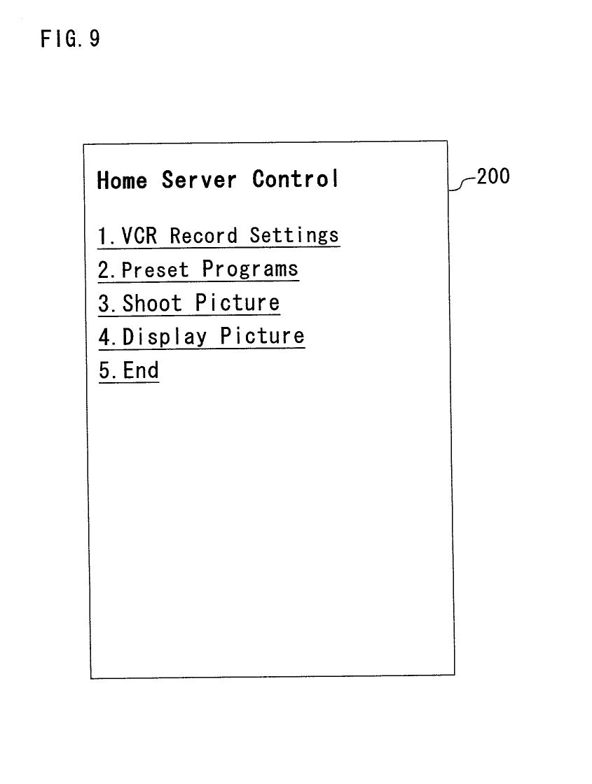

FIGS. 9, 10 and 11 show a procedure to control the VCR 14b or the digital still camera 14e from the user terminal 40, which is a mobile phone, via the home server 20. Here the home server 20 is working as a WWW server for the user terminal 40. The home page of the home server 20 is displayed on a screen 200 of the user terminal 40 as shown in FIG. 4. On the screen, a menu for control, that is, “1. VCR Record Settings,” “2. Preset Programs,” “3. Shoot Picture,” “4. Display Picture” and “5. End” is shown. On this menu, the item 1 is for the user to set up the recording of a TV program. The item 2 is used to check if the settings have been properly entered. The item 3 is used to instruct the digital still camera 14e to shoot an image. The item 4 is used to instruct the camera 14e to send the shot image to the user terminal 40 to be displayed on the screen 200.

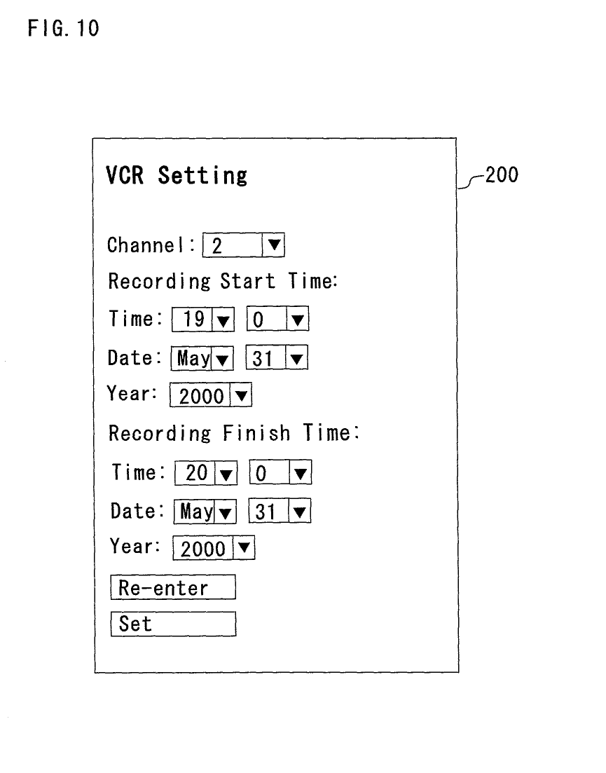

When the user selects the item 1, the screen 200 shown in FIG. 10 is displayed. On this screen, blanks for user input such as “channel,” “recording start time” and “recording finish time” are displayed. “Re-enter” and “set” buttons are also provided at the bottom. When the user clicks the set button after the necessary information is inputted, the home server 20 issues a command which sets the VCR 14b for recordings.

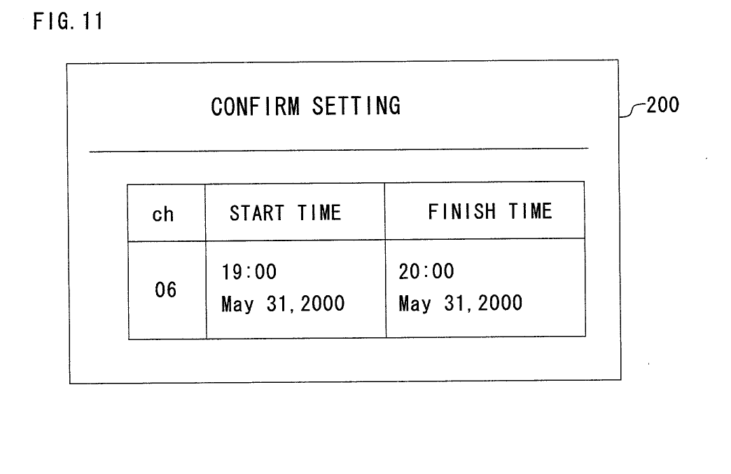

When the user selects the item 2 on the screen of FIG. 9, a new screen image 200 shown in FIG. 11 appears. The TV program requested by the user is actually received as a status report from the VCR 14b and is displayed. When the user goes back to the screen 200 of FIG. 9 and selects the item “3. Shoot Picture,” the digital camera still 14e shoots a picture and sends it to the user terminal 40 when the user selects the item “4. Display Picture.” The picture is then displayed on the user terminal 40. This remote picture shooting can be used for home security and the like.

According to the above embodiment, various merits can be realized. The embodiment is generally advantageous in minimizing communication costs, as it is unnecessary for the home server 20 to be connected to the Internet constantly. The set-up and running costs are both generally reasonable as the home server 20 may be initiated and controlled via a normal public line without using an Integrated Services Digital Network (ISDN) line or any other dedicated lines. The embodiment is convenient for the user as the user may operate the home server 20 using a mobile phone or the like. The embodiment is also advantageous in terms of security as the logical address allotted from the network using the dial-up connection has a random feature. The user can afford to be less anxious about the danger of address leakage compared with the situation where the user uses a fixed address.

Although the present invention has been described by way of exemplary embodiments, it should be understood that many changes and substitutions may be made by those skilled in the art without departing from the spirit and the scope of the present invention which is defined only by the appended claims. A few modifications are now explained.

In the above embodiment, the public switched network 32, the mobile phone network 30, the Internet 36 and the mobile phone packet network 34 are used. There are, however, many other possible combinations of networks to achieve the purpose of the present invention. The most essential condition here is that the user terminal 40, when the home server 20 is disconnected from a certain network, can use an alternative network to activate the home server 20. When the home server 20 is, however, initiated by an internal request such as by a timer, by an external device such as the home network appliance 14 or by a device dependent on ambient environment such as a sensor without a trigger signal from the user terminal 40, the home server 20 and the user terminal 40 may be connected to the same network.

In the above embodiment, the user terminal 40 is a mobile phone. Naturally the user terminal 40 may be any other mobile devices or fixed devices. In a factory, for example, the user terminal 40 may be installed at some distance from a factory line. The operator may remotely operate, control or supervise the line remotely by using the user terminal 40. In the same manner, the home server 20 may be used as an OA server to, for example, amend a printer error remotely, after reference to the error status.

In the above embodiment, the address reporting unit 110 writes the server address in an e-mail message. The e-mail may contain additional information such as a log file showing the status change of the home network appliance 14 which occurred since the last access from the user terminal 40 to the home server 20.

What is claimed is:

1. An information processing apparatus operable from a remote user comprising:
a communication unit which provides a function to interface with a network;
a connection request unit which generates a request to establish a connection with the network;
an address holder which holds a logical address allotted when the connection is established; and
a server function unit which provides a predetermined service, when a network node of the user accesses the apparatus using the sent logical address, to the node as a client.

2. The apparatus of claim 1 further comprising a monitor unit which detects a trigger signal transmitted by a remote node in compliance with a communication protocol which does not require connection to the network, wherein the connection request unit generates the request upon detecting the signal.

3. The apparatus of claim 1 further comprising:
a second communication unit which communicates with an external appliance which is under the control of the apparatus; and
an appliance controller which controls the external appliance via the second communication unit;
wherein the server function unit, as the predetermined service, receives an instruction for the control of the external appliance from the user node and transmits the instruction to the appliance controller and
the appliance controller converts the instruction to a control command of the external appliance and sends the command to the appliance via the second communication unit.

4. The apparatus of the claim 1 further comprising a second monitor unit which generates a trigger signal when status of the external appliance reported via the second communication unit satisfies a predetermined condition, wherein the connection request unit generates the request upon detecting the signal generated by the second monitor unit.

5. The apparatus of claim 1 further comprising a third monitor unit which generates a trigger signal when information from a sensor sensing ambient environment satisfies a predetermined condition, wherein the connection request unit generates the request upon detecting the signal generated by the third monitor unit.

6. The apparatus of claim 1 further comprising a disconnection request unit which disconnects from the network when access from the logical address has been suspended for a predetermined period.

7. The apparatus of claim 2 further comprising an authentication unit which determines whether the remote node that issued the trigger signal is a user node managed by the apparatus.

8. The apparatus of claim 2 further comprising:
a second communication unit which communicates with an external appliance which is under the control of the apparatus; and
an appliance controller which controls the external appliance via the second communication unit;
wherein the server functional unit, as the predetermined service, acquires an instruction for the control of the external appliance from the user node and transmits the instruction to the appliance controller; and
the appliance controller converts the instruction to a control command from the external appliance and sends the command to the appliance via the second communication unit.

9. The apparatus of the claim 3 further comprising a second monitor unit which generates a trigger signal when the status of the external appliance reported via the second communication unit satisfies a predetermined condition, wherein the connection request unit generates the request upon detecting the signal generated by the second monitor unit.

10. The apparatus of claim 4 further comprising a third monitor unit which generates a trigger signal when information from a sensor sensing ambient environment satisfies a predetermined condition, wherein the connection request unit generates the request upon detecting the signal generated by the third monitor unit.

11. The apparatus of claim 5 further comprising a disconnection request unit which disconnects from the network when access from the logical address has been suspended for a predetermined period.

12. An information processing method operable from a remote user comprising:
waiting in a stand-by mode in an off-line state as an initial state;
establishing connection with a network upon detecting a predetermined trigger signal;
receiving and holding a logical address allotted when the connection is established;
sending the held logical address to a network node of the user; and
providing a predetermined service, when a network node of the user connects to the sent logical address, to the node as a client.

13. An information processing apparatus operable from a remote user comprising:
a communication means for providing a function to interface with a network;
a connection request means for generating a request to establish a connection with the network;
an address holding means for holding a logical address allotted when the connection is established; and
a server function means for providing a predetermined service, when a network node of the user accesses the apparatus using the sent logical address, to the node as a client.

14. An information processing method operable from a remote user comprising the steps of:
waiting in a stand-by mode in an off-line state as an initial state;
establishing connection with a network upon detecting a predetermine trigger signal;
receiving and holding a logical address allotted when the connection is established;
sending the held logical address to a network node of the user; and
providing a predetermined service, when a network node of the user connects to the sent logical address, to the node as a client.

15. The apparatus of claim 1, wherein said network is the Internet, wherein the connection request unit relies on Point-to-Point Protocol and wherein the logical address is an Internet Protocol address.

16. The method of claim 12, wherein said network is the Internet, wherein the connection relies on Point-to-Point Protocol and wherein the logical address is an Internet Protocol address.
